(19) United States
(12) Patent Application Publication
(10) Pub. No.: US 2013/0088315 A1
(43) Pub. Date: Apr. 11, 2013

(54) TRANSFORMER WITH ARBITRARILY SMALL LEAKAGE-INDUCTANCE APPARATUS AND METHOD

(71) Applicant: Sedona international, Inc., Nashua, NH (US)

(72) Inventor: Paul Clouser, Williston, VT (US)

(73) Assignee: SEDONA INTERNATIONAL, INC., Nashua, NH (US)

(21) Appl. No.: 13/645,837

(22) Filed: Oct. 5, 2012

Related U.S. Application Data
(60) Provisional application No. 61/544,310, filed on Oct. 7, 2011.

(51) Int. Cl. H01F 5/04; H01F 41/08

(52) U.S. Cl. CPC H01F 5/04; H01F 41/08
USPC 336/182; 242/434

(57) ABSTRACT

An electrical transformer is provided having a toroidal core; a plurality of wraps of a low impedance transmission line the low impedance transmission line including a transmission pair of first and second conductors such that the transformer creates a magnetic flux confined to interfaces between said first and second conductors and does not extend to the toroidal core, and the transformer having a coupling coefficient K arbitrarily close to 1 and a value of leakage inductance Lₗ arbitrarily close to 0.

### RELATED APPLICATIONS

This application claims the benefit of U.S. Provisional Applications No. 61/544,310, filed Oct. 7, 2011. This application is herein incorporated by reference in its entirety for all purposes.

### FIELD OF THE INVENTION

The disclosure relates to electrical power pulse transformers for electrical power conversion circuits and more specifically to such circuits having a scalable general solution to electrical transformer component design that enables a coupling coefficient arbitrarily close to 100% and broadband.

### BACKGROUND OF THE INVENTION

Pulse transformers are the heart of a switching power supply and suffer a parasitic inductance known as leakage inductance that limits today's switched power supplies at ten to fifteen (10 to 15) kilowatts maximum output power for 90% maximum efficiency. Accordingly, need exists for a low to zero leakage inductance power pulse transformer that will enable switched power supplies to operate efficiently at fifteen (15) kilowatts and higher power.

The schematic diagram for a pulse transformer configured according to one embodiment of the present invention is shown in FIG. 1. The problem element is Lₗ, the equivalent leakage inductance of the transformer. This inductance Lₗ is present to some extent in every power electrical transformer manufactured. For sinusoidal power signals, as shown in FIG. 2A-B, typical values of inductance Lₗ cause typically 1% or less loss in efficiency. This is because for sinusoidal power signals the effect of Lₗ can be canceled with the power factor correction capacitor C_{PFC} shown placed between points 1 and 2. The capacitor C_{PFC} thus solves both power reflection and transmission problems. This is because C_{PFC} is tuned with Lₗ to the sinusoidal frequency of the current source in order to vector-cancel the impedance of Lₗ and because the combination of elements C_{PFC}, Lₗ and T can made with very low loss. On the other hand, because of the much shorter transition time Tₛ of the pulse step in the switched square wave current source shown in FIG. 3A-B, the capacitor C₁ cannot be used to reduce the effect of Lₗ on efficiency. This is because in order for the switching transistors to survive the switching transition, the capacitor C₁ must instead be tuned with Lₗ in such a manner as to cancel enough of the much higher voltage Vₚ caused by the much higher forcing frequency Fₛ

$${F}_{s} = \frac{3.4}{{T}_{s}}$$

of the spike response shown in FIG. 4C. It must do this without further increasing the lost current shown in FIG. 4B.

$$\begin{matrix}\sqrt{{L}_{𝓁} Ci} = \frac{1}{2 π {F}_{s}} & ( 2 ) \\ Ri = \sqrt{{L}_{𝓁} / Ci} & ( 3 )\end{matrix}$$

Further the resistor element Rᵢ must be added to damp out the inevitable oscillation between Cᵢ and Lₗ.
Equations (2) and (3) above may be combined to produce design starting values of Cᵢ and Rᵢ directly as functions of Lₗ (see Appendix 1):

Ci=1/[(2πFₛ)²Lₗ] (4)

Ri=Lₗ(2πFₛ) (5)

The lost current Iₗₒₛₛ shown in FIG. 4B is therefore the consequence of the spike generated in Vₚ. Such a spike is not generated in the case of the sinusoidal current source shown in FIG. 2A-B.

What is needed therefore are techniques for decreasing the leakage inductance of pulse transformers and improving their efficiency.

### SUMMARY OF THE INVENTION

One embodiment of the present invention provides an electrical transformer, the transformer having: a toroidal core; a plurality of wraps of a low impedance transmission line the low impedance transmission line comprising a transmission pair of first and second conductors such that the transformer creates a magnetic flux confined to interfaces between the first and second conductors and does not extend to the toroidal core, and the transformer having a coupling coefficient K arbitrarily close to 1 and a value of leakage inductance Ll arbitrarily close to 0.

Another embodiment of the present invention provides such an electrical transformer wherein the first and second conductors are disposed on opposing sides of a non-conductive film.

A further embodiment of the present invention provides such an electrical transformer wherein a wrap in the plurality of wraps comprises first and second turns in the low impedance transmission line such that the second conductor is disposed proximal to the toroidal core.

Yet another embodiment of the present invention provides such an electrical transformer further comprising an electrical input comprising a conductive disc.

A yet further embodiment of the present invention provides such an electrical transformer wherein the conductive disc is copper.

Even another embodiment of the present invention provides such an electrical transformer further comprising an electrical output comprising a conductive disc.

An even yet further embodiment of the present invention provides such an electrical transformer wherein the conductive disc is copper.

Still another embodiment of the present invention provides such an electrical transformer wherein the second conductor is a continuous coil disposed adjacent to the core, the first conductor comprising a plurality of first conductor segments disposed over and parallel with wraps of the second conductor.

One embodiment of the present invention provides a system for the transformation of electrical voltage, the system having: a toroidal core; a continuous secondary conductor disposed about the core; a plurality of primary conductor segments disposed over the continuous secondary conductor; a primary input and a primary output of each primary conductor segment being coupled to, respectively an input disc and an output disc.

Another embodiment of the present invention provides such a system wherein the input disc is copper.

A further embodiment of the present invention provides such a system wherein the output disc is copper.

Yet another embodiment of the present invention provides such a system further comprising an insulative film tape disposed between the first conductor, and the second conductor, wherein the first and second conductors are disposed on opposing surfaces of the insulative film tape.

One embodiment of the present invention provides a method for the manufacture of an electrical transformer, the method having: providing a toroidal core; wrapping the toroidal core with a continuous secondary conductor; disposing a plurality of segments of a primary conductor over wraps of the secondary conductor; and coupling the segments of primary conductor to input and output discs.

Another embodiment of the present invention provides such a method further comprising twisting a single wrap of the secondary conductor and its overlaying segment of primary conductor at first and second positions such that ends of the secondary conductor are accessible for electrical connection.

One embodiment of the present invention provides elimination of the electrical spike voltage response to that current step shown in FIG. 4C.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 Schematic diagram of a circuit known transformer;

FIGS. 2A-B are circuit and function diagrams of a known Sinusoidal Current Source, respectively;

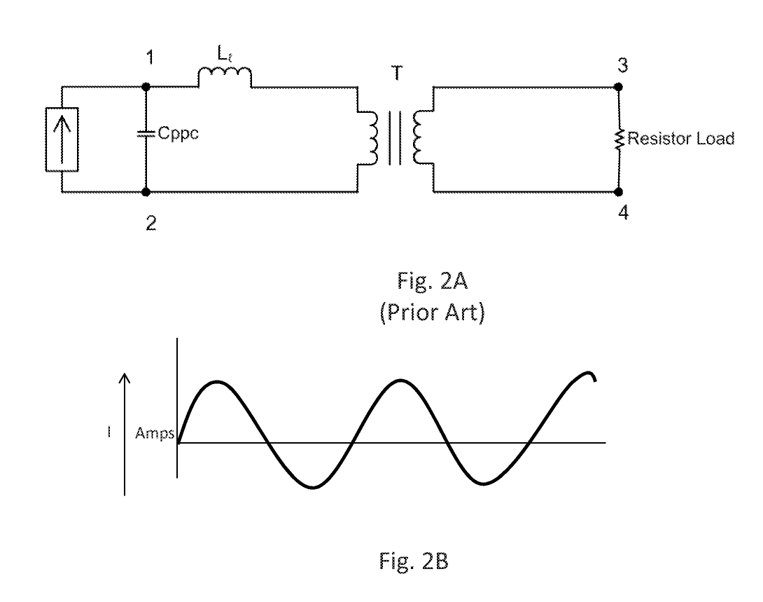

FIGS. 3 A-B are circuit and function diagrams of a Switched Square Wave Current Source configured in accord with one embodiment of the present invention;

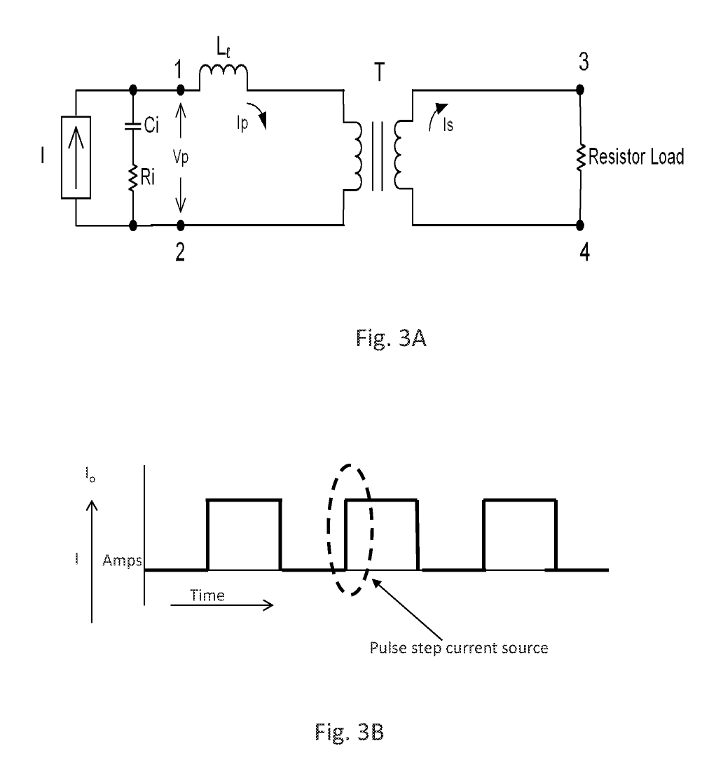

FIGS. 4A-C are Pulse Step Current Source function diagrams configured in accord with one embodiment of the present invention;

FIG. 5 is Ten (10) turns of the segmented parallel plate transmission line wrapped toroidal core transformer configured in accord with one embodiment of the present invention;

FIG. 6 is a partial cutaway diagram of the parallel plate transmission line configured in accord with one embodiment of the present invention;

FIG. 7 is a view of the parallel plate transmission line configuration unrolled and configured in accord with one embodiment of the present invention;

FIG. 8 is a schematic of the parallel plate transmission line configuration interconnect configured in accord with one embodiment of the present invention;

FIG. 9 is a top view of the turn structure of the parallel plate transmission line configuration configured in accord with one embodiment of the present invention;

FIG. 10 is a bottom view of the turn structure of the parallel plate transmission line configuration showing the interconnection disks configured in accord with one embodiment of the present invention;

FIG. 11A is the structure of a single turn of the parallel plate transmission line configuration in accord with one embodiment of the present invention;

FIG. 11B is the structure of a single turn of the parallel plate transmission line uncoiled configuration in accord with one embodiment of the present invention;

FIG. 12A is the structure of a paired secondary conductor configured in accord with one embodiment of the present invention;

FIG. 12B is a perspective view of a single turn at the secondary conductor termination having a pair of turns configured in accord with one embodiment of the present invention;

FIG. 13 is a flow chart of a method for the manufacture of a transformer configured in accord with one embodiment of the present invention;

FIG. 14 is a schematic showing how the leakage inductances interact in accord with one embodiment of the present invention.

### DETAILED DESCRIPTION

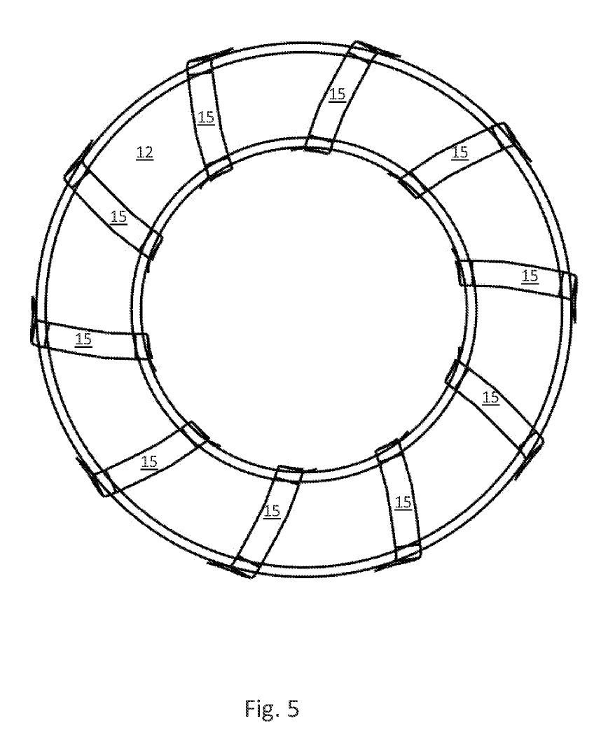

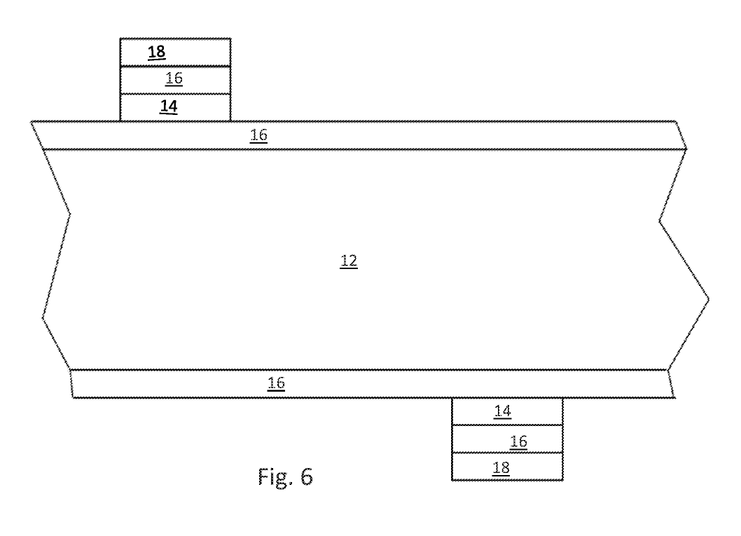

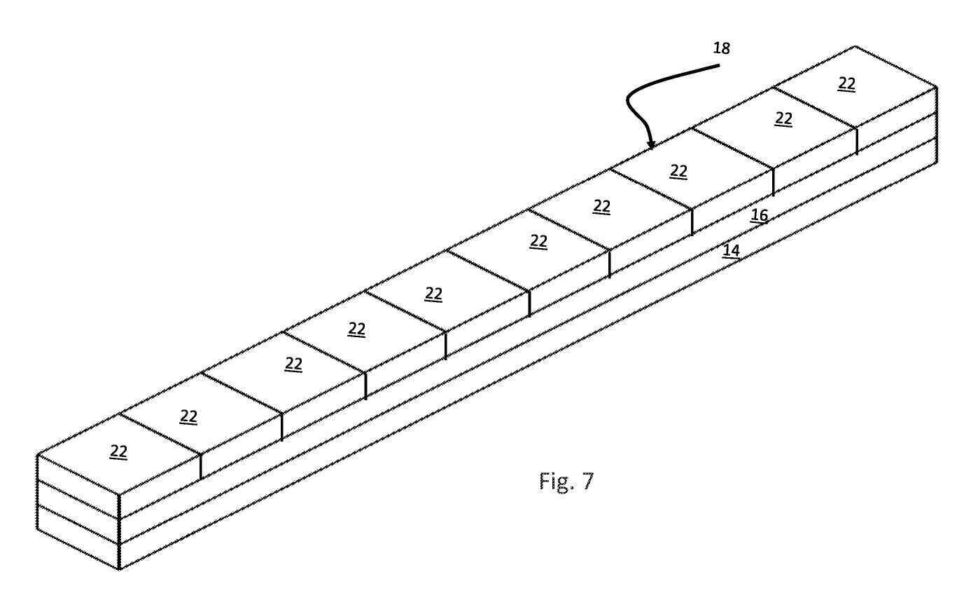

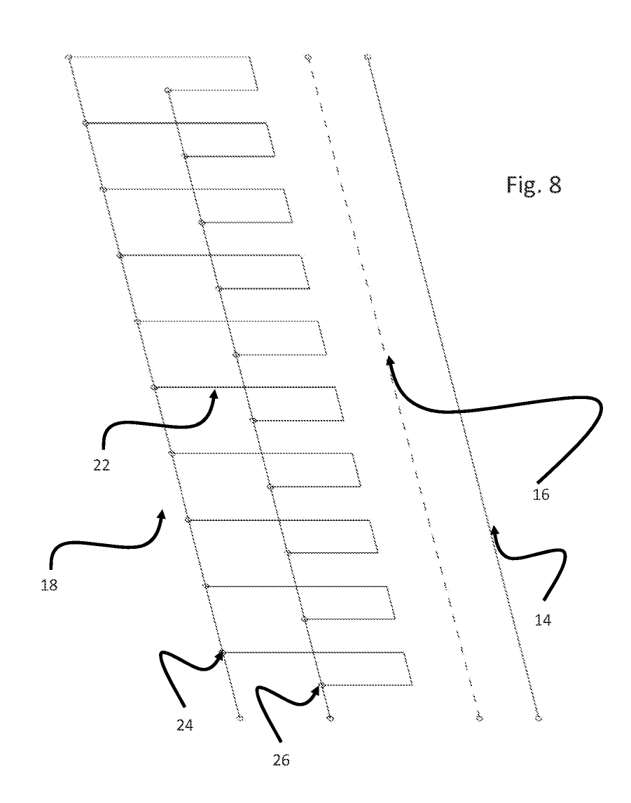

One embodiment of the invention provides a toroidal transformer which consists of a toriodal core wrapped in N (N=10 in this example) turns of segmented arbitrarily low impedance parallel plate transmission line as shown in FIG. 5. The segmented parallel plate transmission line conductor configuration is shown in FIGS. 6 and 7. The interconnection wiring is shown in FIG. 8. The resulting magnetic flux energy is confined to the interface between the conductor pairs. The flux energy does not extend into the transformer core. This is necessary for a coupling coefficient K=1, for which the value of Lₗ=0.

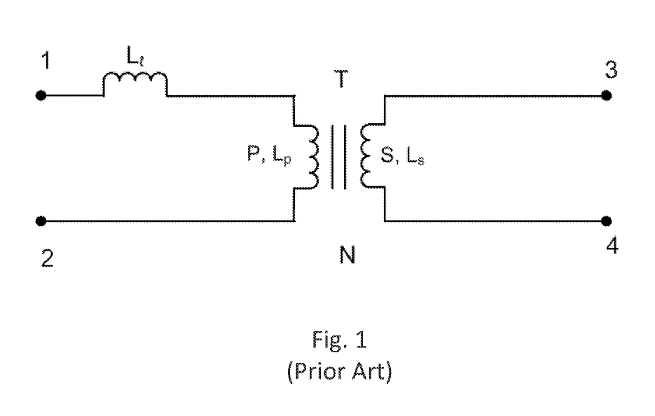

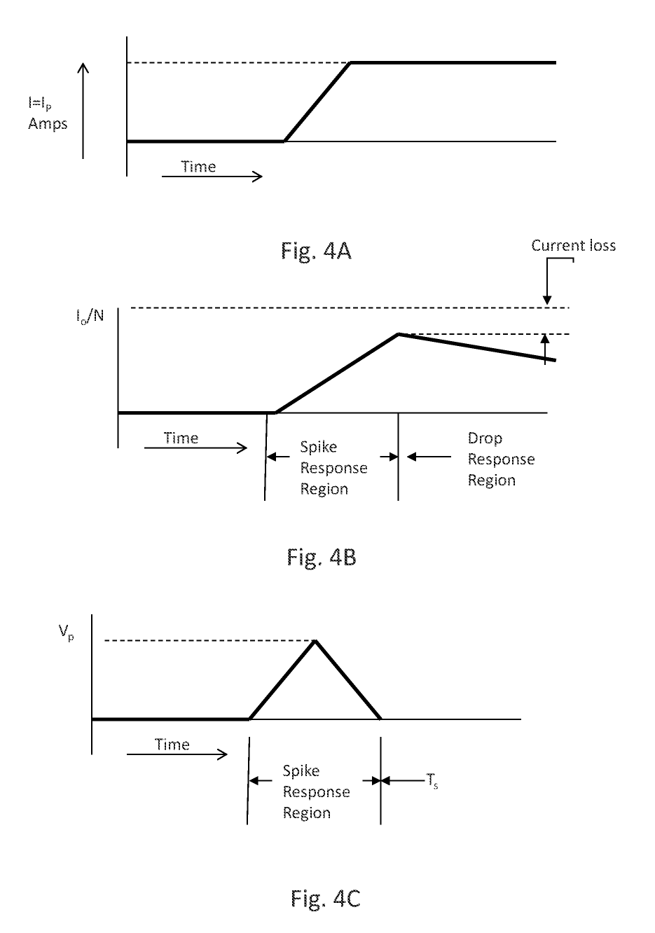

Disclosed is a technique for the reduction of Lₗ to near zero, and, therefore is focused on the spike response region shown in FIG. 4C. Pulse droop is a function of the product LₚLₛ of the two magnetizing inductances Lₚ and Lₛ defined in FIG. 1.

The value of Lₗ is dependent on the coupling coefficient K between the primary conductor P and secondary conductor S in FIG. 1. The coupling coefficient K must equal 1 for zero Lₗ. It is necessary for K=1 that all the electro-magnetic energy lie between the two conductors and must be 100% coupled. To obtain coupling arbitrarily close to 100% the primary and secondary conductors are preferably arbitrarily close to being physically collocated so that the equal and oppositely directed pair of coupled primary and secondary vector current elements come arbitrarily close to canceling each other's vector magnetic field. One embodiment of the present invention provides a design based upon the conductor configuration wrapped around a core 12 wrapped in insulation 17 as shown in FIGS. 5 and 6. It is a primary-secondary pair 15 of flat conductors 14, 18 separated from each other by a thin insulator 16 of arbitrarily small thickness. As the thickness of the insulator 16 between the pair approaches zero the coupling approaches 100% and the leakage inductance approaches zero.

The coupling during the instantaneous pulse rise time depends only on the conductor configuration and not on the core. Therefore, as shown in FIG. 7, the configuration of the primary 18 and secondary 14 conductors may be unwound from the core and flattened out for analysis to obtain the value of leakage inductance. An N=10 turns ratio configuration is shown, but N can be any integer number. The single 10-turn secondary 14 is laid down first around the insulation wrapped core 12, then the insulator 16 between the pairs is added and then the 10 individual primary turns 18 are placed on top of the secondary 14. The primary turns 18 are formed into 10 individual loops 22 around the core in such a manner that the 10 primary turns can be interconnected in parallel as shown in the schematic FIG. 8. The N=10 secondary turns are series wound as also shown in FIG. 8.

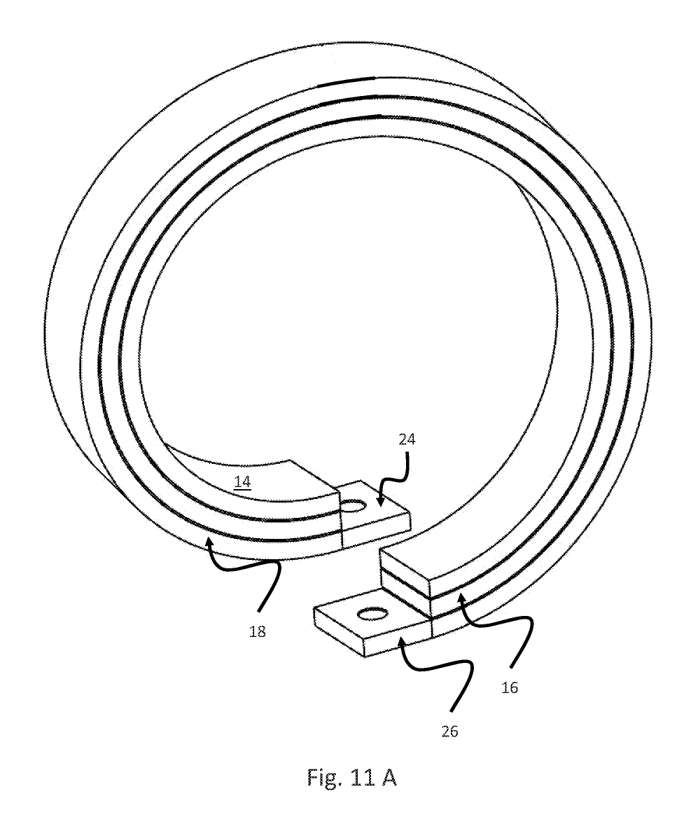

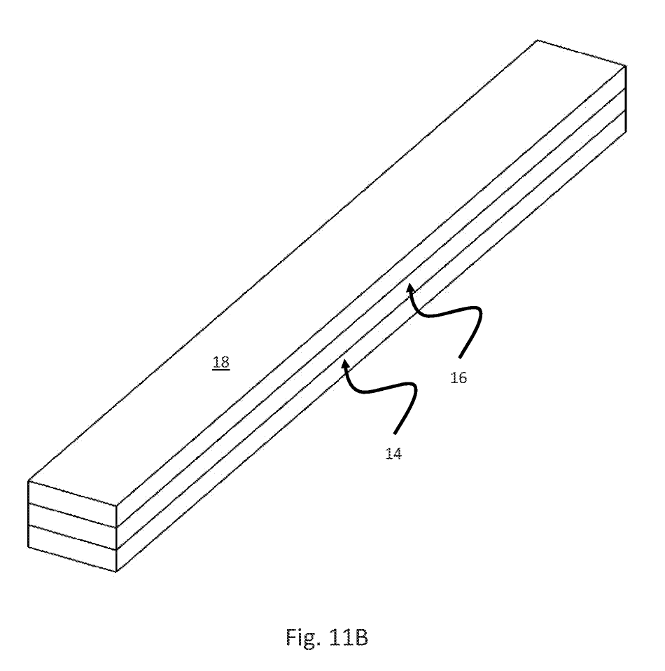

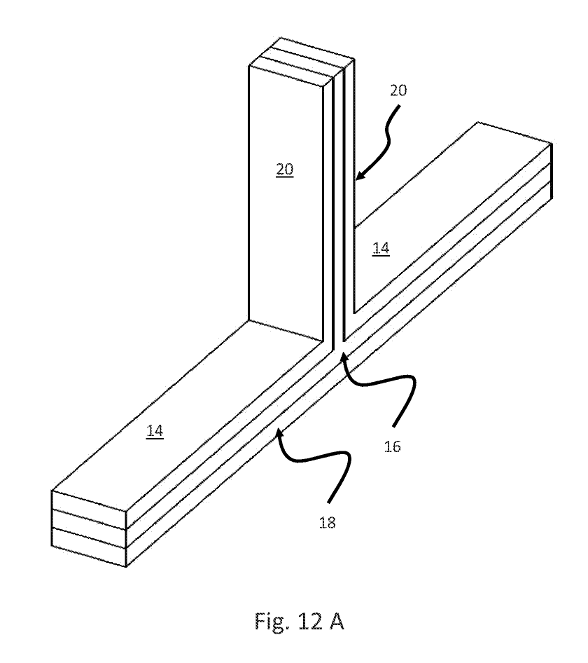

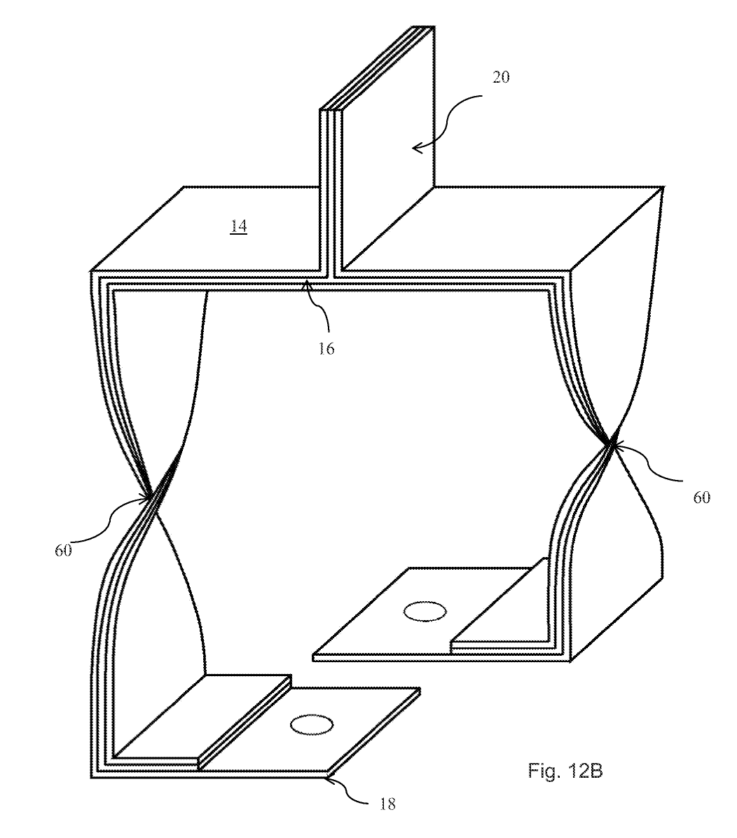

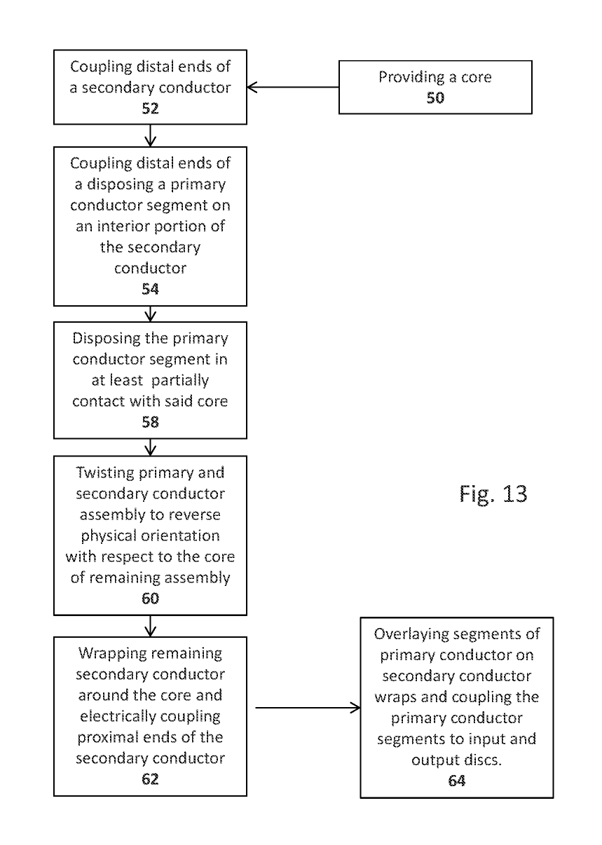

As illustrated in FIG. 13, the one embodiment of the present invention provides a method for manufacturing a pulsed transformer as, illustrated in FIGS. 11A-12B. In assembling the system, according to one embodiment, a core 12 is provided 50. A secondary conductor 14 of a length sufficient to be wrapped around the core a predetermined number of times (in one embodiment 10) is disposed on a bobbin. In one embodiment of the present invention, more than one bobbin may be used. The secondary conductor 14 may be provided with an insulative or non-conductive coating or film 16. A primary conductor section 18 is also provided of sufficient length to complete a single wrap around the core 12. In embodiments where two bobbins of secondary conductor 14 are provided, distal ends of the secondary conductor 20 are adhered 52 such that the conductor ends 20 are parallel and separated by the non-conductive film 16. The two sections of secondary conductor 14 are then bent at the point where the two sections meet and the primary conductor 18 section 22 is disposed across the meeting point 54. The assembly of secondary 14 and primary 18 conductors is then applied 58 to the core 12, such that the primary conductor 18 is proximate to the core 12 and the secondary conductor distal ends 20 are external to the wrap. The assembly is then twisted 60 in two points such that after the two points ends of the primary conductor section are distal to the core 12 and the secondary conductor 14 (with its proximal ends still disposed on the bobbins for ease of handling) are disposed proximate to the core 12. The remainder of the secondary conductor is wrapped 62 about the core 12 the desired number of times proximate to the core 12. Each turn of the secondary conductor is then overlaid with an additional primary conductor segment 22. The input 24 and output ends 26 of each additional primary conductor segment 22 are then electrically coupled to input 28 and output discs 30 respectively 64.

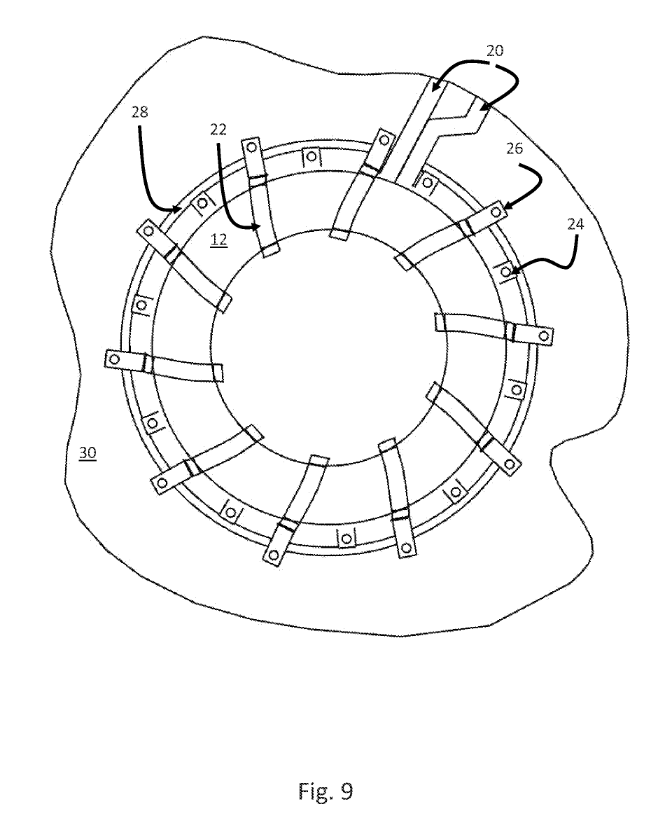

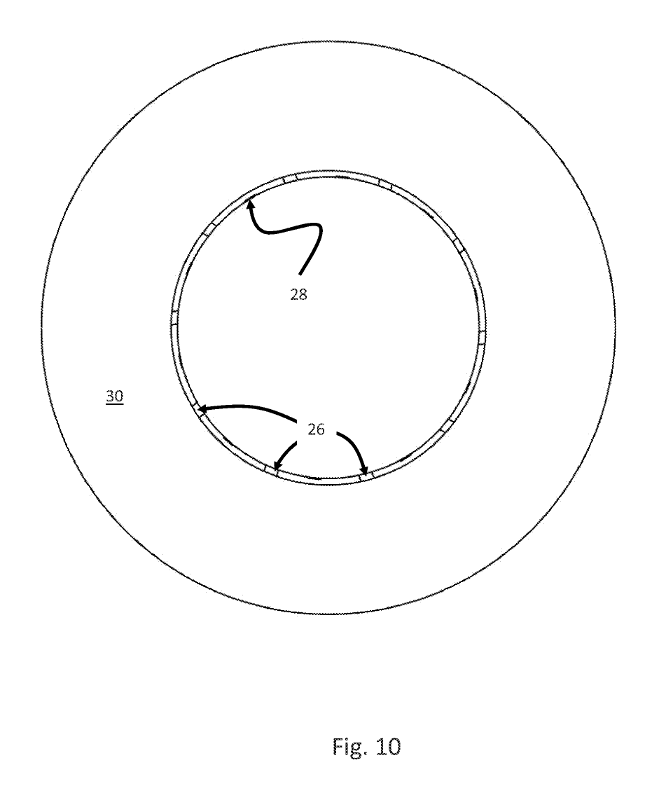

A hardware embodiment of this configuration is shown in FIG. 9 Top View and FIG. 10 Bottom View. FIG. 9 shows the primary input and output for each turn connected to a corresponding input copper disk 28 and an output copper disk 30. FIG. 10 shows the configuration of the copper disks. These two disks are the primary conductor buses. They are made cylindrically symmetric to fit the application need for a low inductance connection to a similarly shaped capacitor substrate and ground return. The two ends of the secondary 10-turn winding are shown in FIG. 9 as Secondary In Line and Secondary Out Line.

FIGS. 11A-11B shows a single turn both as its actual appearance in the hardware configuration of one embodiment as a physical loop, and also laid out flat for analysis. FIG. 12B shows a configuration of one turn that lets the secondary winding escape most efficiently as a pair of tabs or a transmission line pair. It adds two twists as shown in order to place the secondary conductor turn in position on the outside of the turn for ease of exit. The equations for mutual Lₘ and mutual Cₘ for the parallel plate physical parameters length of the secondary conductor (l), width of the transmission line (W) and the thickness of the insulator 16 (h) defined in FIGS. 11A and 11B are:

Lm=μ₀ hl/W(Henries),

Cm=ε₀εᵣ Wl/h(Farads),

μ₀=4π×10⁻⁷(Henries/Meter),

μ₀=1/(c²μ₀)(Farads/Meter),

c=3×10⁸(Meters/Second).

The mutual inductance Lₘ and the mutual capacitance Cₘ between the two conductors for one loop is that loop's contribution to the primary leakage inductance L_{LP}, secondary leakage inductance L_{LS}, and primary to secondary mutual capacitance C_{PS}. In FIGS. 7 and 8 it is shown that the primary leakage inductance L_{LP} of the primary conductor 18 is the N=10 inductors 22 of value Lₘ connected in parallel so that:

L_{LP}=Lₘ/N=Lₘ/10.

It is also shown in FIGS. 7 and 8 that the secondary leakage inductance L_{LS} of the secondary conductor 14 is the N=10 inductors 22 of value Lₘ connected in series so that

L_{LS}=NLₘ=10Lₘ.

Combining the two above equations yields the relation between L_{LS} and L_{LP}:

L_{LS}=N²L_{LP}=10²L_{LP}=100L_{LP},

L_{LP}=L_{LS}/N²=L_{LS}/10²=L_{LS}/100.

One embodiment of the present invention has the values of the parameters W, h, l and εᵣ as:

W=0.25 in=6.35×10⁻³ m,

h=0.006 in=0.152×10⁻³ m,

l=3.625 in=0.0921 m,

c=3×10⁸ m/s,

Applying these values to the equations given above for Lₘ and Cₘ yields:

Lₘ=μ₀hl/W=2.77 nH

Cₘ=ε₀εᵣWl/h=0.102 nF.

The primary leakage inductance L_{LP} and secondary leakage inductance L_{LS} then are:

L_{LP}=Lₘ/N=Lₘ/10=0.277 nH

L_{LS}=NLₘ=10Lₘ=27.7 nH.

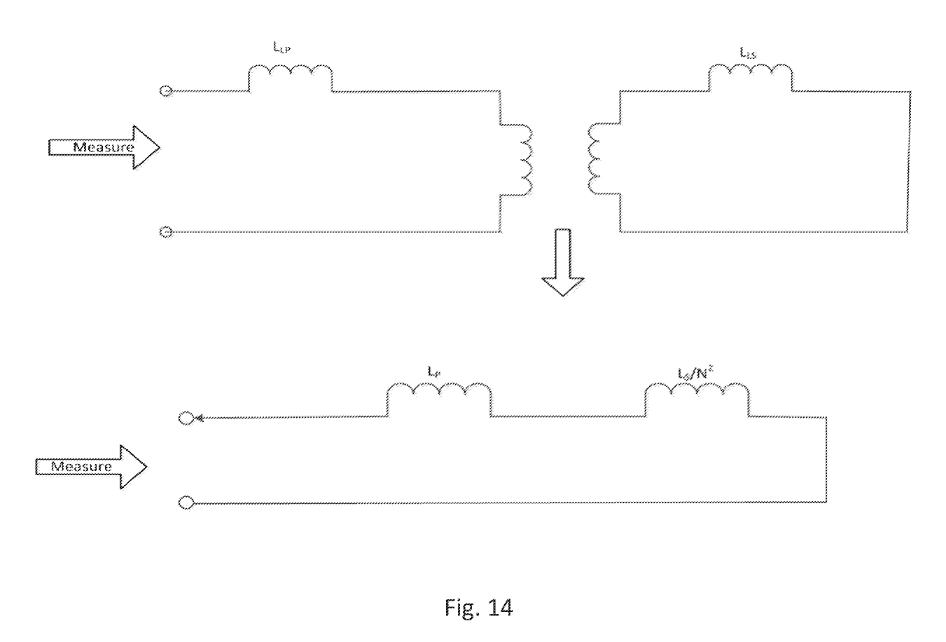

These inductances L_{LP} and L_{LS} each affect the measurement of the other as shown in FIG. 14. What is measured as L_{LPM} shown in FIG. 14 is L_{LP} plus L_{LS} transformed by the transformer turns ratio 1/N² such that:

L_{LPM}=L_{LP}+L_{LS}/N²,

And since it has been shown above that for this case of the parallel plate transmission line configuration:

L_{LS}=N²L_{LP},

It follows that by substitution:

L_{LPM}=L_{LP}+N²L_{LP},/N²,

L_{LPM}=2L_{LP}

By the same reasoning:

L_{LSM}=L_{LS}+N²L_{LP},

L_{LSM}=2L_{LS}

This means that the measured leakage inductance for the parallel plate transmission line configuration will be twice that of the value calculated from Lₘ. It also means that the leakage inductances to be used for calculating inductive spike levels should be L_{LPM} if looking at the spike from the primary side of the transformer, or L_{LSM} if looking at the spike from the secondary side of the transformer. Note that for the actually built and tested version of the hardware configuration of FIGS. 9 and 10 this means that the values of the leakages should be doubled:

L_{LPM}=2L_{LP}=2×0.277=0.554 nH,

L_{LSM}=2L_{LS}=2×22.7=55.4 nH

for analytical calculation of the leakage inductance spike. For circuit software models such as SPICE the values of L_{LP} should be used on the primary side and L_{LS} should be used on the secondary side because the SPICE transformer models properly handle the transformation between the two elements used together.

In one embodiment of the present invention the percent of efficiency % E degradation % E_{d} in the power converter application that is caused by transformer leakage inductance is:

%E_{d}=50L_{LPM}Iᵢₙf/Vᵢₙ,

where Lᵢₙ is the input current to the converter and Vᵢₙ is the input voltage to the converter and f is the converter switching frequency. For this 2000 watt design:

Vᵢₙ=48V,

Iₙ=2,000/48=42 A,

L_{LPM}=0.554 nH,

f=90 KHz

the percent efficiency degradation % E_{d} due to the transformer windings leakage inductance is:

%E_{d}=0.002%.

This is extremely low. If Iᵢₙ were increased by a factor of 50 for a 100,000 Watt design the percent efficiency degradation due to the transformer leakage inductance would be only:

%E_{d}=0.1%.

An extremely low contribution of transformer leakage inductance to switched power supply efficiency keeps transformer leakage inductance from limiting switched power supply performance to ten to fifteen (10 to 15) kilowatts and much higher power at 90% and higher efficiency % E. For these power ranges the effect of transformer leakage inductance will be practically zero compared to the inductive, capacitive and resistive parasitic elements of the converter critical switched current loops and the transformer internal interconnect wiring.

Among the many applications of coupling coefficient arbitrarily close to 100% are pulse transformers that exhibit leakage inductance arbitrarily close to zero.

Among the many advantages of leakage inductance arbitrarily close to zero are transformer dependent power converters that exceed 15 Kilowatts with high efficiency.
T: Designation Transformer
Ll: Equivalent Leakage Inductance
P: Primary conductor winding of X turns with magnetizing inductance Lp
S: Secondary conductor winding of Y turns with magnetizing inductance Ls
N: Secondary to primary conductor turns ratio
Ls: Inductance measured between points 3 and 4 with points 1 and 2 open current as shown
Lp: Inductance measured between points 1 and 2 with points 3 and 4 open circuit as shown and also with a value of Ll of zero

$${L}_{𝓁} {C}_{i} = \frac{1}{{( 2 π {F}_{s} )}^{2}} \to \begin{matrix}{C}_{i} = \frac{1}{{( 2 π {F}_{s} )}^{2} {L}_{𝓁}} \\ \end{matrix}$$

$${R}_{i}^{2} = \frac{{L}_{𝓁}}{{C}_{i}}$$

$${R}_{i}^{2} = \frac{{L}_{𝓁}}{\frac{1}{{( 2 π Fs )}^{2} {L}_{𝓁}}} = \frac{{L}_{𝓁}^{2}}{{( 2 π {F}_{s} )}^{2}}$$

$$\begin{matrix}Ri = \frac{{L}_{𝓁}}{2 π Fs} \\ \end{matrix}$$

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

I claim:

1. An electrical transformer, said transformer comprising:
a toroidal core;
a plurality of wraps of a low impedance transmission line said low impedance transmission line comprising a transmission pair of first and second conductors such that said transformer creates a magnetic flux confined to interfaces between said first and second conductors and does not extend to said toroidal core, and
said transformer having a coupling coefficient K arbitrarily close to 1 and a value of leakage inductance Lₗ arbitrarily close to 0.

2. The electrical transformer of claim 1 wherein said first and second conductors are disposed on opposing sides of a non-conductive film.

3. The electrical transformer of claim 1 wherein a wrap in said plurality of wraps comprises first and second turns in said low impedance transmission line such that said second conductor is disposed proximal to said toroidal core.

4. The electrical transformer of claim 1 further comprising an electrical input comprising a conductive disc.

5. The electrical transformer of claim 4 wherein said conductive disc is copper.

6. The electrical transformer of claim 1 further comprising an electrical output comprising a conductive disc.

7. The electrical transformer of claim 6 wherein said conductive disc is copper.

8. The electrical transformer of claim 1 wherein said second conductor is a continuous coil disposed adjacent to said core, said first conductor comprising a plurality of first conductor segments disposed over and parallel with wraps of said second conductor.

9. A system for the transformation of electrical voltage, said system comprising:
a toroidal core;
a continuous secondary conductor disposed about said core;
a plurality of primary conductor segments disposed over said continuous secondary conductor;
a primary input and a primary output of each primary conductor segment being coupled to, respectively an input disc and an output disc.

10. The system of claim 9 wherein said input disc is copper.

11. The system of claim 9 wherein said output disc is copper.

12. The system of claim 9 further comprising an insulative film tape disposed between said first conductor, and said second conductor, wherein said first and second conductors are disposed on opposing surfaces of said insulative film tape.

13. A method for the manufacture of an electrical transformer, said method comprising:
providing a toroidal core;
wrapping said toroidal core with a continuous secondary conductor;
disposing a plurality of segments of a primary conductor over wraps of said secondary conductor; and
coupling said segments of primary conductor to input and output discs.

14. The method of claim 13 further comprising twisting a single wrap of said secondary conductor and its overlaying segment of primary conductor at first and second positions such that ends of said secondary conductor are accessible for electrical connection.
